(19) United States
(12) Patent Application Publication
(10) Pub. No.: US 2010/0243554 A1
(43) Pub. Date: Sep. 30, 2010

(54) Fluid Filter Assembly

(76) Inventors: Nathan Herrin, Conroe, TX (US); Robb Benson, Montgomery, TX (US); Mathews Thundyil, The Woodlands, TX (US); Mohammad Farooq, Spring, TX (US); Doug Mittlesteadt, Saline, MI (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/411,091

(22) Filed: Mar. 25, 2009

(51) Int. Cl. B01D 27/07; B01D 29/00; B01D 29/50

(52) U.S. Cl. 210/457; 210/493.2; 210/485; 210/487

(57) ABSTRACT

Some embodiments of the disclosure are directed to a fluid filter assembly including an outer filter element having a hollow core and an inner filter element having a hollow core. The inner filter element can be positioned within the hollow core of the outer filter element, thereby defining an internal fluid passage. In some embodiments, the first end of the outer filter element and the first end of the inner filter element can be supported by an open endcap assembly, which can also include a fluid inlet in fluid communication with the internal fluid passage. In some embodiments, at least one of the filter elements can include a pleated filter media.

### BACKGROUND

The disclosure relates to filters, filter assemblies and filtration applications, such as those which involve using replaceable filter assemblies having one or more filter elements secured by a support frame.

### SUMMARY

Some embodiments of the disclosure provide a fluid filter assembly including a pleated filter element, an open endcap assembly, and a joint endcap. The pleated filter element can include a first end, a second end, and a hollow core. Pleats of the pleated filter element include a plurality of extended pleats separated by one or more intermediate pleats. The extended pleats and the intermediate pleats can project radially inward to a different length. The radially inward projecting length of the extended pleats can be greater than the radially inward projecting length of the intermediate pleats. The open endcap assembly can be configured for supporting the first end of the pleated filter element. The joint endcap can be configured for supporting the second end of the pleated filter element. The joint endcap can be closed to define the hollow core. The open endcap assembly can include a fluid inlet in fluid communication with the hollow core, wherein fluid flows from within the hollow core through the pleated filter element.

Some embodiments of the disclosure provide a fluid filter assembly including an outer filter element and an inner filter element. The outer filter element can include a hollow core. The inner filter element can be positioned within the hollow core of the outer filter element, thereby defining an internal fluid passage between the outer filter element and inner filter element. The outer filter element can further include a first end and a second end. The inner filter element can include a first end, a second end, and a hollow core. The fluid filter assembly can include an open endcap assembly and a joint end cap. The open endcap assembly can be configured for supporting the respective first end of the outer filter element and the inner filter element. The open endcap assembly can include a fluid inlet in fluid communication with the internal fluid passage. The joint endcap can be configured for supporting the respective second end of the outer filter element and the inner filter element. The joint endcap can include a central fluid outlet in fluid communication with the hollow core of the inner filter element. Fluid can flow from within the internal fluid passage through the outer filter element and/or through the inner filter element into the hollow core of the inner filter element.

### DESCRIPTION OF THE DRAWINGS

FIG. 1 is a perspective view of a fluid filter assembly according to one embodiment of the disclosure.

FIGS. 2-3 are additional perspective views of a fluid filter assembly of FIG. 1, including cut-away portions of an exemplary filter elements which may be employed in some embodiments of the disclosure.

FIG. 4 is a top view of the fluid filter assembly of FIG. 1.

FIG. 5 is a cross-sectional view of the fluid filter assembly such as the one shown in FIG. 1, taken along line 5-5 of FIG. 4.

FIG. 6 is another cross-sectional view of the fluid filter assembly of FIG. 1 taken along line 5-5 of FIG. 4, illustrating, among other things, a tubular support member in the core of an exemplary inner element which may be employed in some embodiments of the disclosure.

FIG. 7 is a top view of a open endcap assembly configured according to some embodiments of the disclosure.

FIG. 8 is a cross-sectional view of the open endcap assembly of FIG. 7 taken along line 8-8 of FIG. 7.

FIG. 9 is an exploded perspective view of the open endcap assembly of FIG. 7.

FIG. 10 is a perspective view of the open endcap assembly of FIG. 7.

FIG. 11 is perspective view of fluid filter assembly according to another embodiment of the disclosure, illustrating another embodiment of a open endcap assembly, among other things.

FIG. 12 is a top view of another embodiment of a open endcap assembly configured according to some embodiments of the disclosure.

FIG. 13 is a cross-sectional view of the open endcap assembly of FIG. 12, taken along line 13-13 of FIG. 12.

FIG. 14 is an exploded perspective view of the open endcap assembly of FIG. 12.

FIG. 15 is a perspective view of the open endcap assembly of FIG. 12.

FIG. 16 is a simple schematic illustration of fluid flow through a filter assembly constructed according to some embodiments of the disclosure incorporated in a filter housing.

FIG. 17 is a perspective view of an exemplary pleat formation which may be employed in a filter element for use with some embodiments of the filter assembly of the disclosure.

FIG. 18 is a top plan view of the exemplary pleat formation of FIG. 17.

FIG. 19 is a perspective view of another exemplary pleat formation which may be employed in a filter element for use with some embodiments of the filter assembly of the disclosure.

FIG. 20 is a top plan view of the exemplary pleat formation of FIG. 19.

FIG. 21 is a perspective sectional view of the exemplary pleat formation of FIG. 17 supported along the outer circumference thereof by a tubular support member according to some embodiments of filter elements which may be employed in a filter assembly of the disclosure.

FIG. 22 is a schematic plan view of a section of the embodiment of the filter element shown in FIG. 21, illustrating the radially outward direction of fluid flow therethrough, among other things.

FIG. 23 is a perspective view of the fluid filter assembly with the outer filter element including a cage according to one embodiment of the invention.

FIG. 24 is a close-up of FIG. 23 illustrating a fluid flow path according to one embodiment of the invention.

FIG. 25 is a plan view of a section of the embodiment of the filter element shown in FIG. 21.

FIG. 26 is a plan view of a section of another embodiment of a filter element including a pleat media supported by a tubular support member along the outer circumference thereof, illustrating another exemplary pleat formation, among other things.

FIG. 27 is a plan view of a section of another embodiment of a filter element including a pleat media supported by a tubular support member along the outer circumference thereof, illustrating another exemplary pleat formation, among other things.

FIG. 28 is a plan view of a section of another embodiment of a filter element including a pleat media supported by a tubular support member along the outer circumference thereof, illustrating another exemplary pleat formation, among other things.

FIGS. 29-33 illustrate top plan views of a plurality of different exemplary pleat formations which may be employed in a filter element for use with some embodiments of the disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

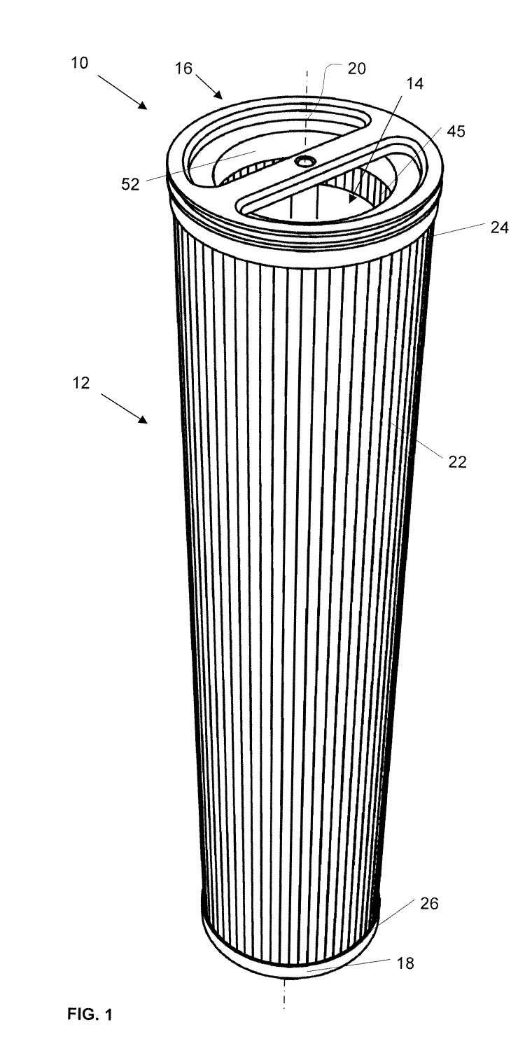

FIGS. 1-3 illustrate a filter assembly 10 according to one embodiment of the disclosure, in which the filter assembly 10 generally includes an outer filter element 12, an inner filter element 14, an open endcap assembly 16, and a joint endcap 18. In some embodiments, the filter assembly 10 can be generally cylindrically shaped and positioned about a central longitudinal axis 20. In some embodiments, the filter assembly 10 can be generally cylindrical, but the filter assembly 10 is not limited to any particular shape.

In other embodiments, the filter assembly 10 can be configured in other shapes. It should be readily apparent that many of the features and components of the filter assembly 10 can differ in shape depending on the application, while still being within the purview of the disclosure. In particular, it should be understood that the design and configuration of various features and components can change to correspond with or complement one another. For example, the open endcap assembly 16 and the joint endcap 18 can be generally circular in shape to correspond with the generally circular ends of the outer filter element 12 and the inner filter element 14. However, the open endcap assembly 16 and the joint endcap 18 can differ in shape to correspond with the shape of the outer filter element 12 and the inner filter element 14, which can also differ in shape from the embodiment shown and described herein. Alternatively, it should be understood that the open endcap assembly 16 and the joint endcap 18, or any other features and components described herein, may not correspond with the shape of any other features and components.

The outer filter element 12 can include a side wall 22, a first end 24, and a second end 26. The inner filter element 14 can include a side wall 28, a first end 30, and a second end 32. The outer filter element 12 can include a hollow core 45. The outer filter element 12 and the inner filter element 14 can be positioned concentrically with respect to each other, thus defining a generally annular fluid passage 34 in the space between the side wall 22 of the outer filter element 12 and the side wall 28 of the inner filter element 14.

In some embodiments, as shown in FIGS. 5 and 6, the outer filter element 12 can be fabricated to be longitudinally tapered, in that a radial length of the side wall 22 from the central axis 20 gradually decreases from the first end 24 to the second end 26. In some embodiments, a radial length of the side wall 22 from the central axis 20 gradually increases from the first end 24 to the second end 26. In some embodiments, the inner filter element 14 can be tapered, in that a radial length of the side wall 28 from the central axis 20 gradually decreases from the first end 30, to the second end 32. In some embodiments, a radial length of the side wall 28 from the central axis 20 gradually increases from the first end 30 to the second end 32. The inner filter element 14 can include a substantially hollow core 33 allowing fluid flow therein, as shown in FIG. 5. In other embodiments, the inner filter element 12 can include an center cage 35 disposed in the hollow core 33. The center cage 35 can be formed of a lattice-like structure, include apertures or otherwise be perforated in some embodiments. The center cage 35 can be fabricated of any material configured with apertures capable of providing desirable flow characteristics without unduly compromising structural integrity.

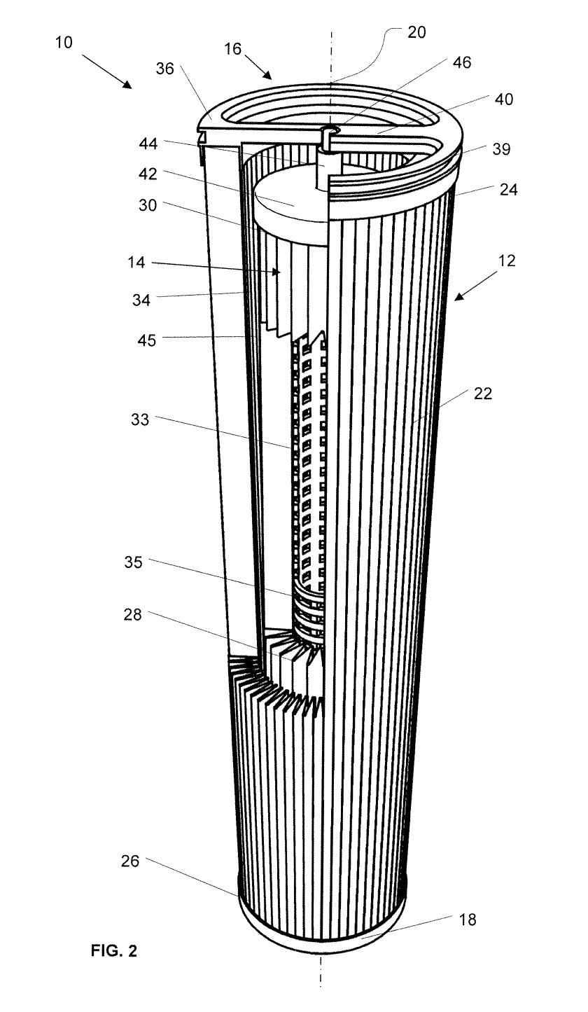

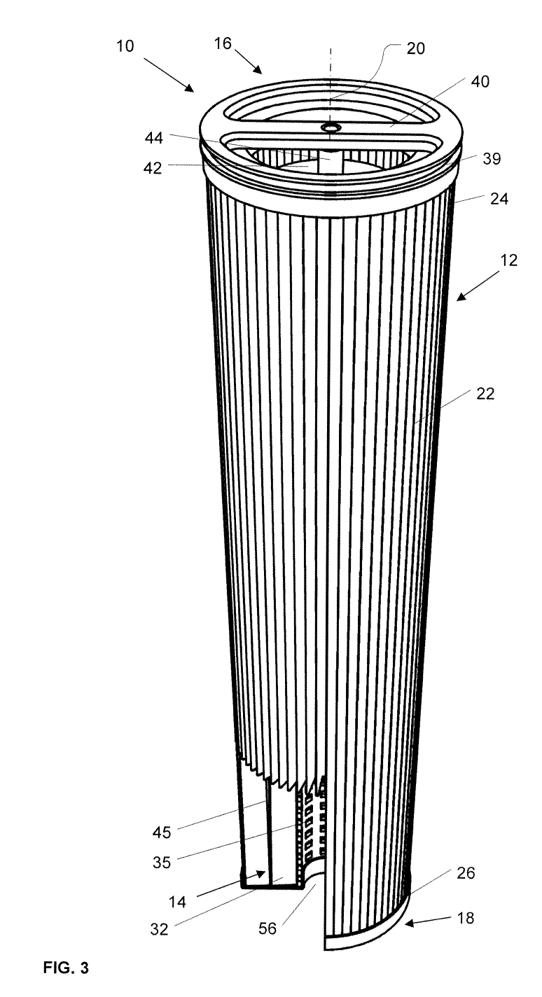

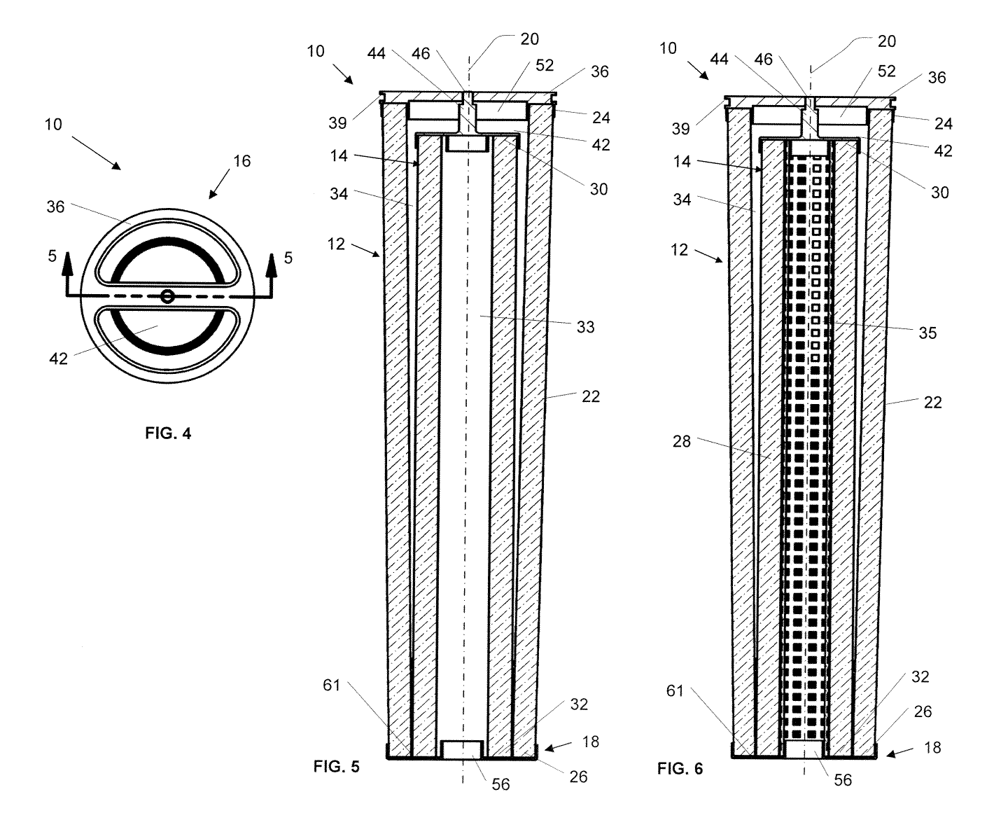

As shown with particularity in FIGS. 2 and 3, the inner filter element 14 may not be longitudinally tapered in one embodiment, but rather, a radius of the side wall 28 from the axis 20 can stay substantially constant from the first end 30 to the second end 32. Thus, in some embodiments, the side wall 28 of the inner filter element 14 can have a substantially constant radius along its longitudinal axis. However, the inner filter element 14 can be tapered in other embodiments.

The axial taper in the outer filter element 12 can cooperate with the substantially constant radius of the side wall 28 of the inner filter element 14 to constrict the annular fluid passage 34 in the portion of the filter assembly 10, which can be adjacent the joint endcap 18. Thus, the volume of the annular fluid passage 34 can gradually decrease from the first end 24 to the second end 26.

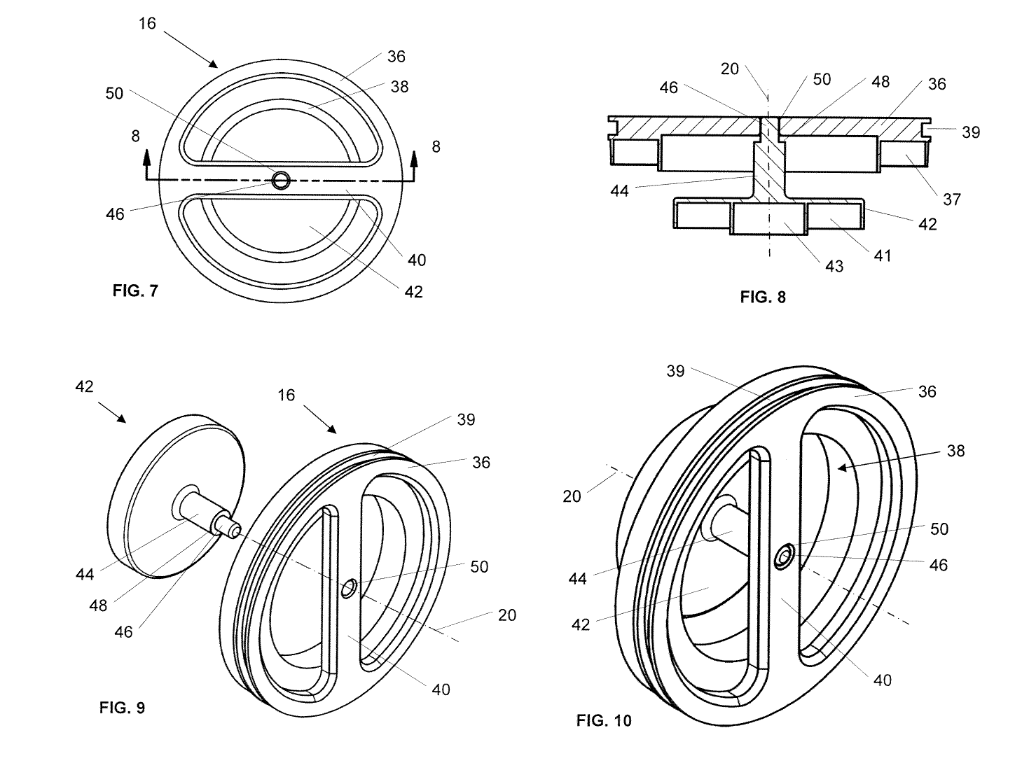

As shown in FIGS. 7-10, the open endcap assembly 16 can include an open endcap 36 having an annular receiving channel 37 configured to receive the first end 24 of the outer filter element 12 therein. Alternatively, the open endcap 36 may not include the channel 37 and the first end 24 can be attached to the open endcap 36 by methods such as those involving adhesives, ultrasonic welding and/or thermal bonding, for example. In some embodiments, the open endcap 36 can seal the first end 24 of the outer filter element 12, as shown, for example, in FIGS. 5 and 6. The open endcap 36 can prevent fluid from entering the outer filter element 12 at substantially the first end 24. The open endcap 36 can also include a peripheral annular channel 39. The open endcap 36 can define a circular fluid inlet 38 and can further include a crossbeam 40 that can extend diametrically across the open endcap 36 through the fluid inlet 38. It is envisioned that the crossbeam 40 can also be used as a handle to lift and maneuver the filter assembly 10. It should be understood that the shape of the crossbeam 40 and the filter assembly 10 can differ from the embodiments shown in the accompanying figures and described herein. These embodiments are merely exemplary and not to be construed as limiting.

The open endcap assembly 16 can further include a closed endcap 42 having all annular receiving channel 41 configured to receive the first end 30 of the inner filter element 14 therein. Alternatively, the cap member 42 may not include the channel 41 and the first end 30 can be attached to the cap member 42 by methods such as those involving adhesives, ultrasonic welding and/or thermal bonding, for example. In some embodiments, the closed endcap 42 can seal the first end 30 of the inner filter element 14, as shown, for example, in FIGS. 5 and 6. The closed endcap 42 can prevent fluid from entering the inner filter element 14 at substantially the first end 30. The cap member 42 can include a central receiving port 43, which can, in some embodiments, be configured to receive one end of the center cage 35 in the hollow core 33. The cap member 42 can further include an arm 44, which can extend axially upward from the cap member 42 with respect to the central axis 20. The arm 44 can include a projection 46, which, in some embodiments, can extend axially upward with respect to the central axis 20 from the arm 44. The projection 46 can define an annular shoulder 48 surrounding a base of the projection 46 on the arm 44. The crossbeam 40 can further include an aperture 50, which can be positioned and configured to receive the projection 46 therein, while the shoulder 48 can abut or can be adjacent to the crossbeam 40 next to the aperture 50. It should be readily apparent that the open endcap 36 and the cap member 42 of the open endcap assembly 16 can be engaged with one another using an alternative configuration in accordance with the disclosure.

In one embodiment, the open endcap 36 and the cap member 42 can be configured to form an engagement that can support and maintain the inner filter element 14 in substantially parallel alignment with respect to the central axis 20 and in a position, which can be axially offset from the outer filter element 12. As a result, the first end 24 of the outer filter element 12 and the first end 30 of the inner filter element 14 can be spaced axially apart from one another. In one embodiment, the first end 30 of the inner filter element 14 can be axially offset or otherwise lower relative to the first end 24 of the outer filter element 12, thus forming an inner trough 52 within the periphery of side wall 28 adjacent the open endcap assembly 16. In other embodiments, the open endcap assembly 16 can be configured so that the inner filter element 14 can be axially offset higher relative to the outer filter element 12. In some embodiments, the open endcap assembly 16 can be configured so that the inner filter element 14 and the outer filter element 12 can be supported at substantially the same axial position, that is, without an axial offset.

The joint endcap 18 can include an annular receiving channel 61, which can be configured to seat both, the second end 26 of the outer filter element 12 and the second end 32 of the inner filter element 14, respectively. Alternatively, the joint endcap 18 may not include the channel 61 and the second ends 26 and 32 can be attached to the open endcap 36 by methods such as those involving adhesives, ultrasonic welding and/or thermal bonding, for example. In some embodiments, the joint endcap 18 can seal the second end 26 of the outer filter element 12 and the second end 32 of the inner filter element 14, as shown, for example, in FIGS. 5 and 6. The joint endcap 18 can force a fluid to leave the outer filter element 12 and the inner filter element 14 upstream of the corresponding second end 26, 32. In some embodiments, the outer filter element 12 and the inner filter element 14 can be supported by the joint endcap 18 in the substantially same axial position. Alternatively, the joint endcap 18 can be configured so that the inner filter element 14 can be axially offset, either higher or lower, relative to the outer filter element 12. The joint endcap 18 can further include a central fluid outlet 56, which can project axially upward into the hollow core 33, or the center cage 35 in some embodiments, thus providing for the egress of filtered fluid from the filter assembly 10.

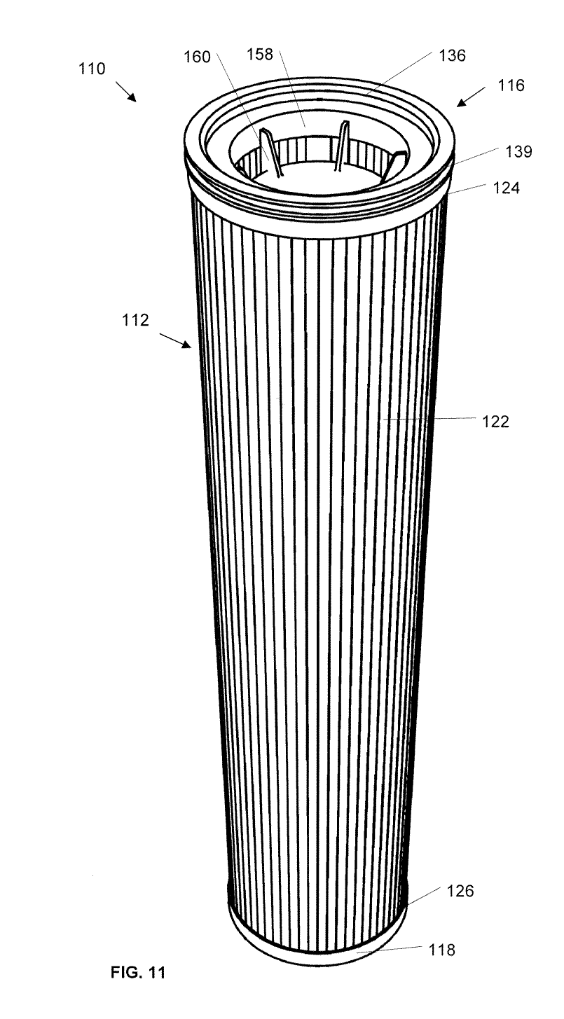

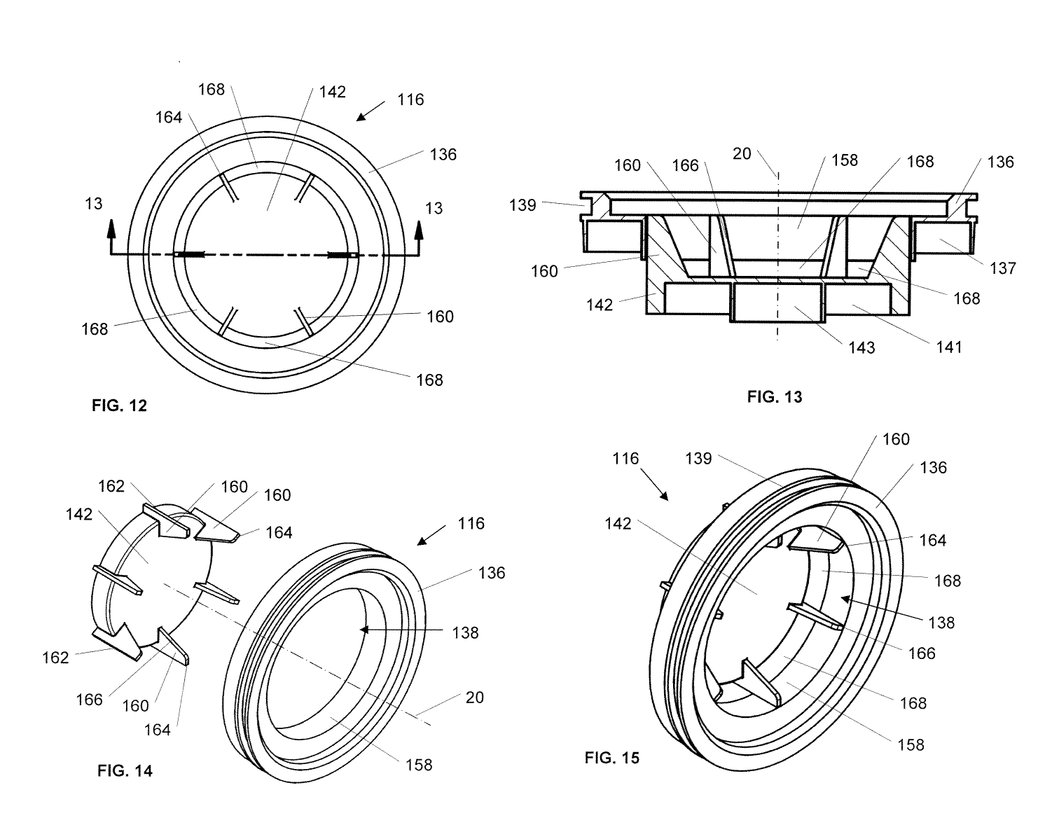

In another embodiment shown in FIGS. 11-15, a filter assembly 110 includes an open endcap assembly 116 including an open endcap 136 and an annular receiving channel 137 configured to receive a first end 124 of the outer filter element 112 therein. Alternatively, the open endcap 136 may not include the annular receiving channel 137 and the first end 124 can be attached to the open endcap 136 by methods such as those involving adhesives, ultrasonic welding and/or thermal bonding, for example. The open endcap 136 can also include a peripheral annular channel 139. The open endcap 136 can define a circular fluid inlet 138 and an inner rim 158. The open endcap assembly 116 can also include a closed endcap 142 having an annular receiving channel 141 configured to receive a first end 130 of an inner filter element 114. Alternatively, the closed endcap 142 may not include the annular receiving channel 141 and the first end 130 can be attached to the closed endcap 142 by methods such as those involving adhesives, ultrasonic welding and/or thermal bonding, for example. The closed endcap 142 can include a plurality of circumferential fins 160 spaced apart from one another along a periphery of the closed endcap 142. Each fin 160 can include a radially outer edge 162, which can extend axially from the closed endcap 142, a planar end 164, and a radially inner edge 166. The fluid inlet 138 of the open endcap 136 can be configured and dimensioned to receive the closed end cap 142 therein. Upon assembling the filter assembly 110, the outer edges 162 of each fin 160 can abut an inner rim 158 of the open endcap 136 to support the closed end cap 142 and the inner filter element 114 to be concentric with the open endcap 136. As a result, the first end 130 of the inner filter element 114 can be concentric with the first end 124 of the outer filter element 112, forming inlet apertures 168 in the spaces between adjacent fins 160.

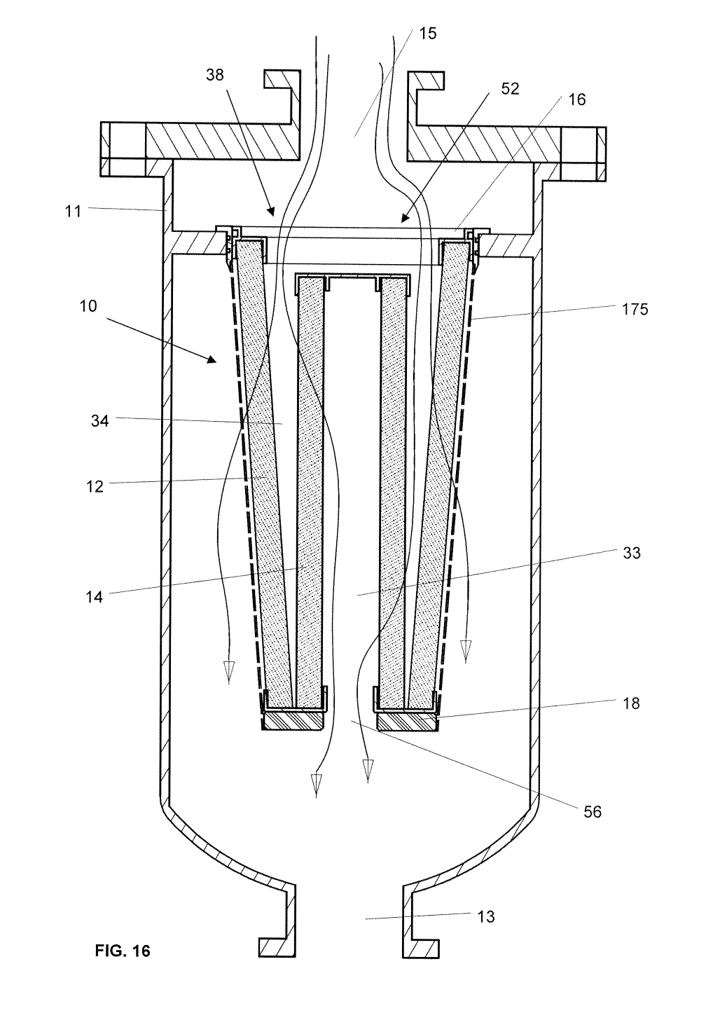

As shown in FIG. 16, the filter assembly 10 can be secured within a filter housing 11 having an inlet fluid conduit 15 and an outlet fluid conduit 13, wherein the inlet conduit 15 can be in fluid communication with the filter assembly 10 to deliver unfiltered fluid to the fluid inlet 38. The outlet conduit 13 can be in fluid communication with the filter assembly 10 to receive filtered fluid from the outer filter element 12 and the inner filter element 14. As schematically illustrated by arrows in FIG. 16, fluid flow through the fluid inlet 38 associated with the open endcap assembly 16 can enter the trough 52 and the annular fluid passage 34. The trough 52 can facilitate minimizing the pressure drop of fluid flowing to the trough 52 and into the annular fluid passage 34 and the hollow core 45 to avoid any undesirable pressure change or fluid flow characteristics, among other things. Fluid can either be forced or drawn through the outer filter element 12, the inner filter element 14, or both for fluid filtration by the filter assembly 10. Filtered fluid can exit the filter housing 11 through the outlet conduit 13.

In one embodiment, the outer filter element 12 and/or the inner filter element 14 can be fabricated of a generally circumferentially pleated filter media. Pleats of the pleated filter media can be of varying formation. For example, in some embodiments, the pleats can be formed so that lateral pleats are substantially similar, lateral pleats substantially differ, or alternating pleats are substantially similar.

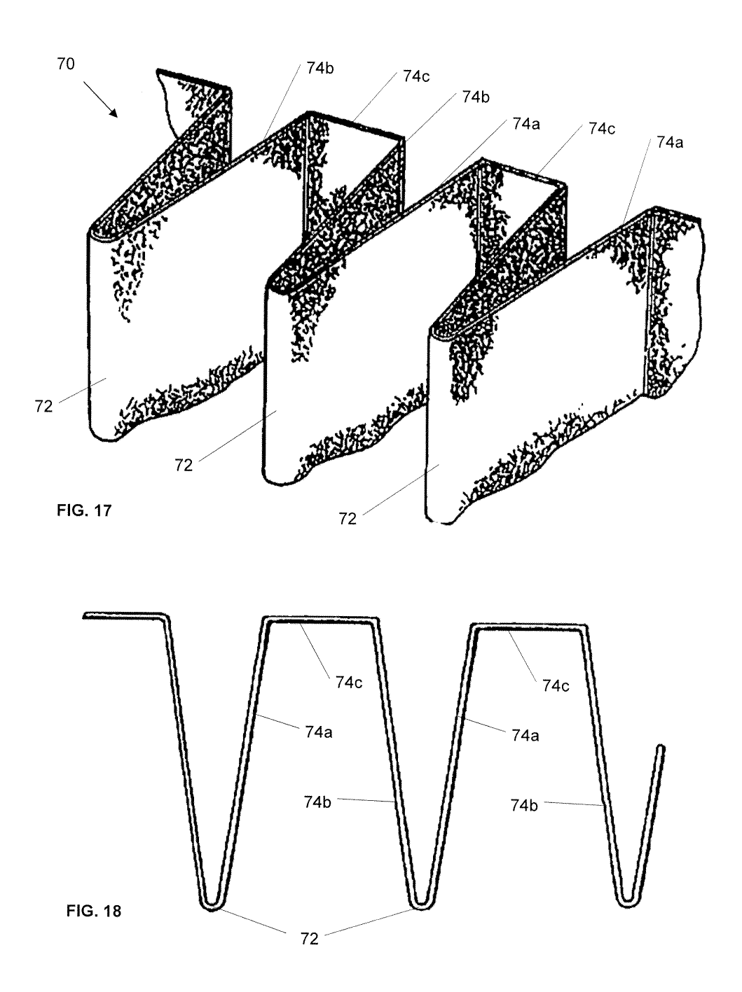

Referring now to FIGS. 17 and 18, there is illustrated one exemplary pleat formation designated by reference numeral 70, which can be advantageously employed in either one or both the outer filter element 12 and the inner filter element 14. The pleat formation 70 can include radially projecting pleats 72, each having first pleat legs 74a and second pleat legs 74b of substantially equal height. In the pleat formation 70, the first pleat leg 74a of one pleat 72 can be joined to the second pleat leg 74b of a preceding pleat 72 by a flat medial pleat section 74c.

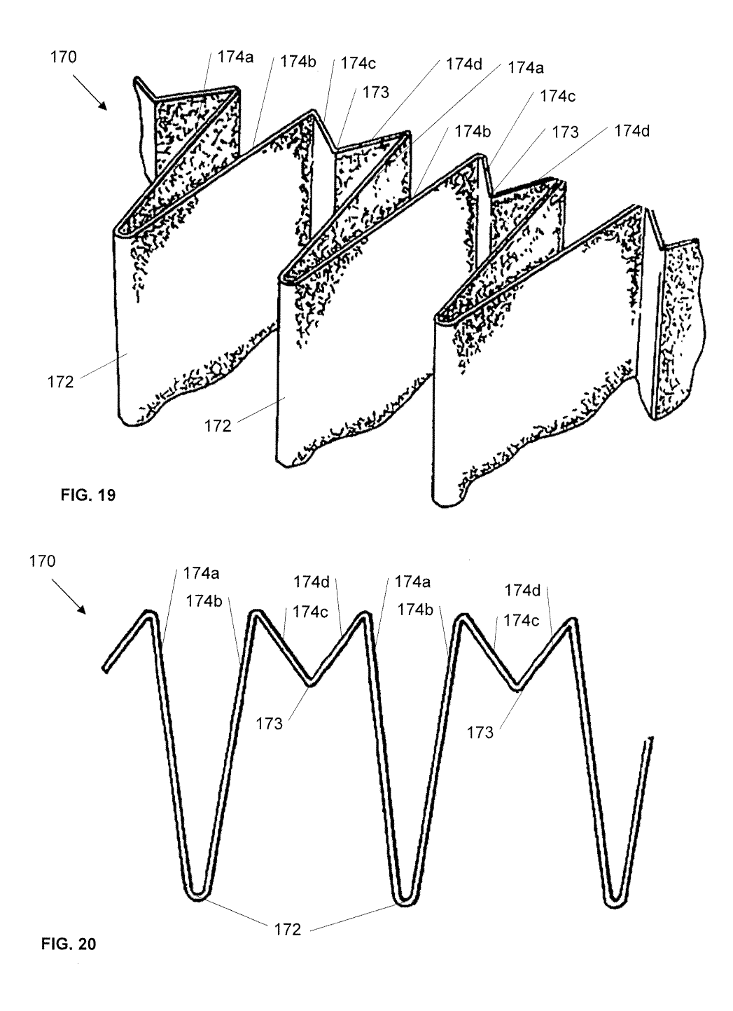

Referring now to FIGS. 19-22, there is illustrated another exemplary pleat formation designated by reference numeral 170, which can be advantageously employed in one or both the outer filter element 12 and the inner filter element 14. The pleat formation 170 can include radially projecting pleats 172, each of which can have first pleat legs 174a and second pleat legs 174b of substantially equal height. In the pleat formation 170, the first pleat leg 174a of one pleat 172 can be joined to the second pleat leg 174b of a preceding pleat 172 by an intermediate pleat section 173 that can include two intermediate pleat segments 174c and 174d of about equal length. As a result, the pleat formation 170 can take the general form of a W-shape construction, that is, consisting essentially of alternating tall and short lateral pleats, with either angular or rounded creases depending on the embodiment.

It is envisioned that the W-shaped configuration of the pleat formation 170, or the alternative embodiments discussed herein below, can be employed to maintain adjacent pleat surfaces of filter sleeves in spaced apart relationship to avoid contact with one another over the majority of the axial length of either the outer filter element 12 and/or the inner filter element 14, in which the pleat formation 170 can be employed, thus providing less flow restriction, among other things. Also, the pleat formation 170, or the alternative embodiments discussed herein below, can provide greater filtration surface area over the same volume as other configurations. The pleated filter media can be fabricated of a variety of materials, such as materials which are pliable yet sufficiently stiff or resilient to maintain the desired pleat formation.

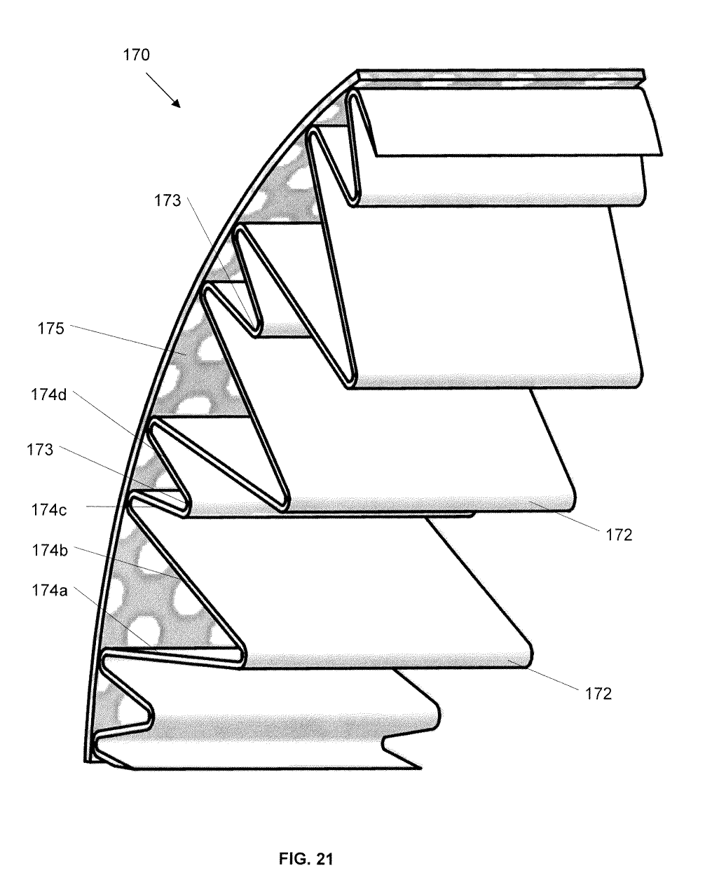

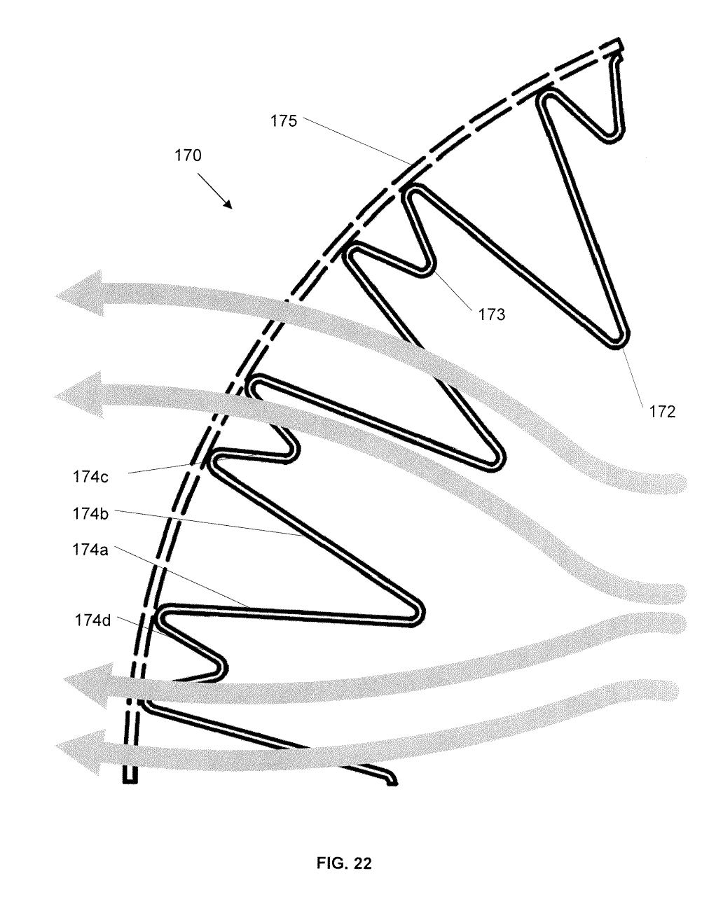

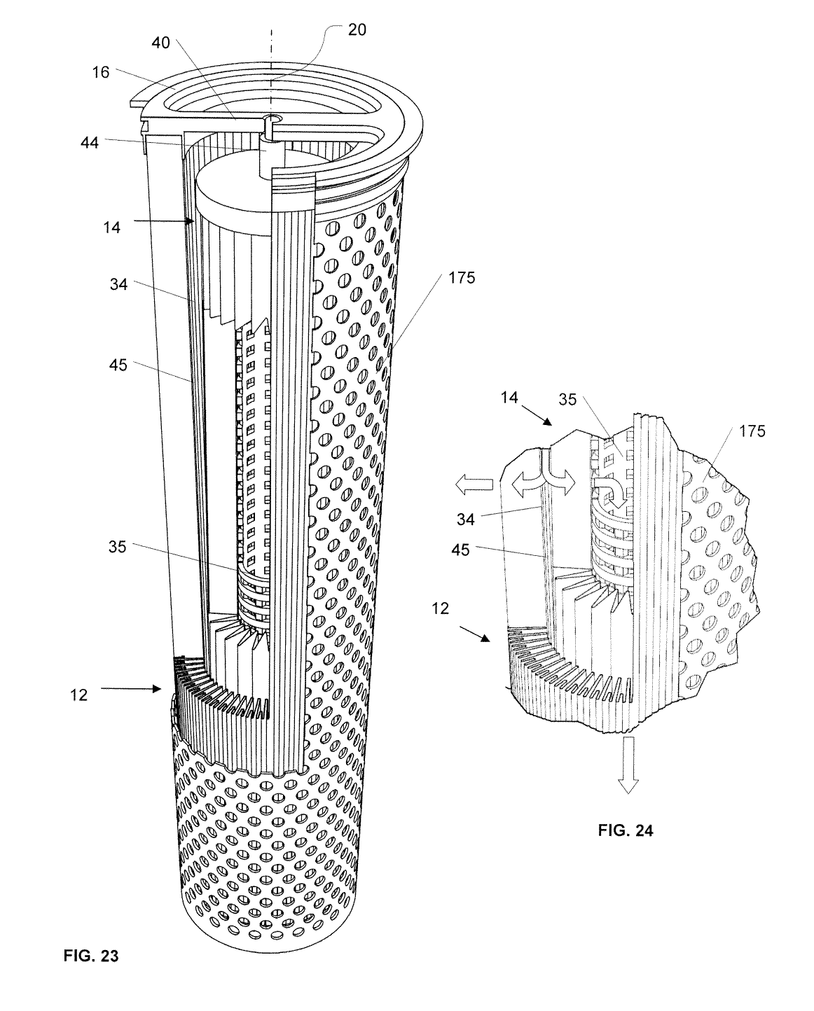

As shown particularly in FIG. 21, in some embodiments of the invention, a pleat formation, such as the pleat formation 170, can be supported along the outer circumference thereof by a support member, such as a cage 175 as shown herein. Although this embodiment illustrates a tubular cage 175, it should be understood that the cage 175 can correspond with the general shape of the outer filter element 12 and/or the inner filter element 14. The cage 175 can also include apertures or perforated sidewalls in some embodiments. The pleat formation 170 can be supported by the cage 175 such that the extended pleat sections 172 and the intermediate pleat sections 173 extend substantially radially inward from the cage 175. As illustrated by the arrows in FIG. 22, in some embodiments, the filter assembly 10 can be configured for fluid flow generally radially outward through the pleated filter media in the pleat formation 170 and through the cage 175. The pleat formation 170 can be aligned in such a way that the intermediate pleat section 173 can extend in a direction substantially opposite to the direction of the flow. As a result, the radially projecting pleats 172 and the intermediate section 173 can be supported in the direction of the flow by the cage 175. FIGS. 23 and 24 illustrate an embodiment, in which the cage 175 can be disposed on the outer filter element 12. Some other embodiments can also include a center cage, which can include apertures therein.

The outer filter element 12 and the inner filter element 14 can be substantially the same or different longitudinal lengths. In some embodiments, the filter assembly 10 can include the outer filter element 12 having the pleat formation 170, with or without an axial taper, but with no inner filter element 14. In other embodiments, the filter assembly 10 can include the outer filter element 12 having the pleat formation 170, with or without an axial taper, with the inner filter element 14 having the same or a different pleat formation. It should be understood that either one or both the outer filter element 12 and the inner filter element 14 can be formed of any filtration media suitable for the filtration application.

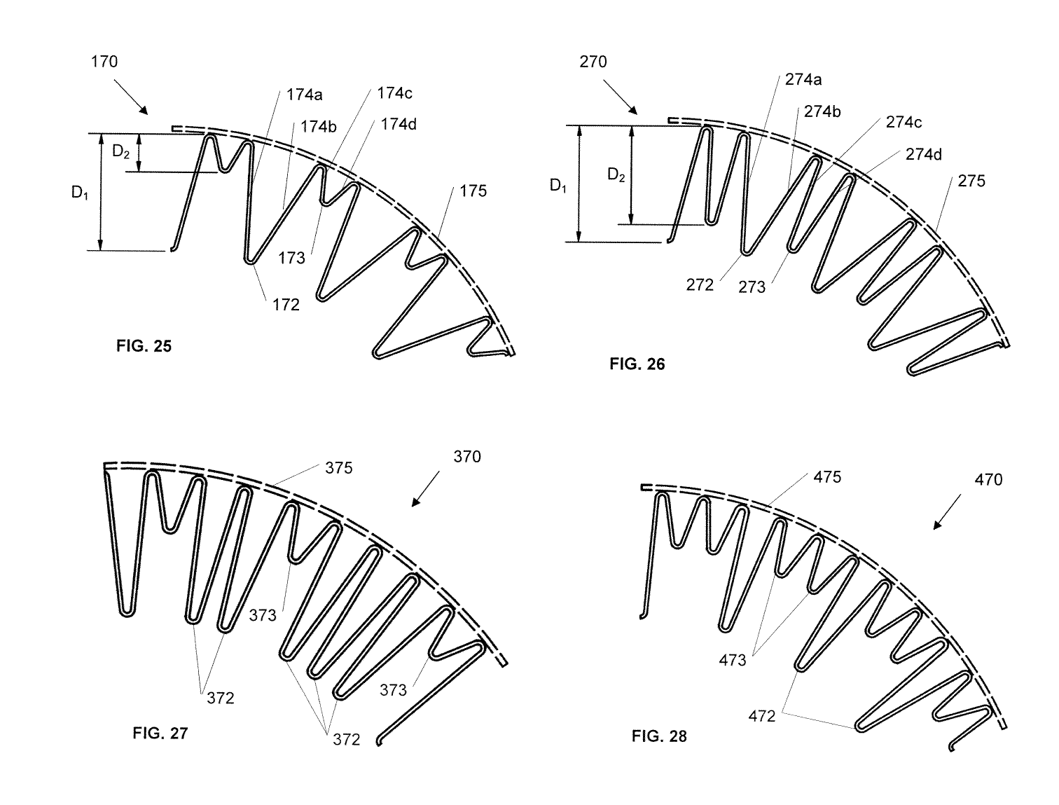

As shown in FIG. 25, in some embodiments the pleat formation 170 can include the extended pleat section 172, which can extend radially inward from the cage 175 by a distance D1, and the intermediate pleat section 173, which can extend radially inward from the cage 175 by a distance D2. As shown, in some embodiments, the distance D1 can be substantially greater than the distance D2. As shown in FIG. 26, a pleat formation 270 can include a pleat 272, which can extend radially inward from an cage 275 by a distance D1, and an intermediate pleat section 273, which can extend radially inward from the cage 275 by a distance D2. As shown, in some embodiments, the distance D1 can be substantially equal to the distance D2.

FIG. 27 illustrates a pleat formation 370, in which one or more adjacent pleats 372 can be separated by an intermediate pleat section 373. FIG. 28 illustrates a pleat formation 470, in which each pleat 472 can be separated by one or more adjacent intermediate pleat sections 473. The pleat formations 370 and 470 can each be supported such that their respective pleats and intermediate pleat sections extend substantially radially inward from the respective cage.

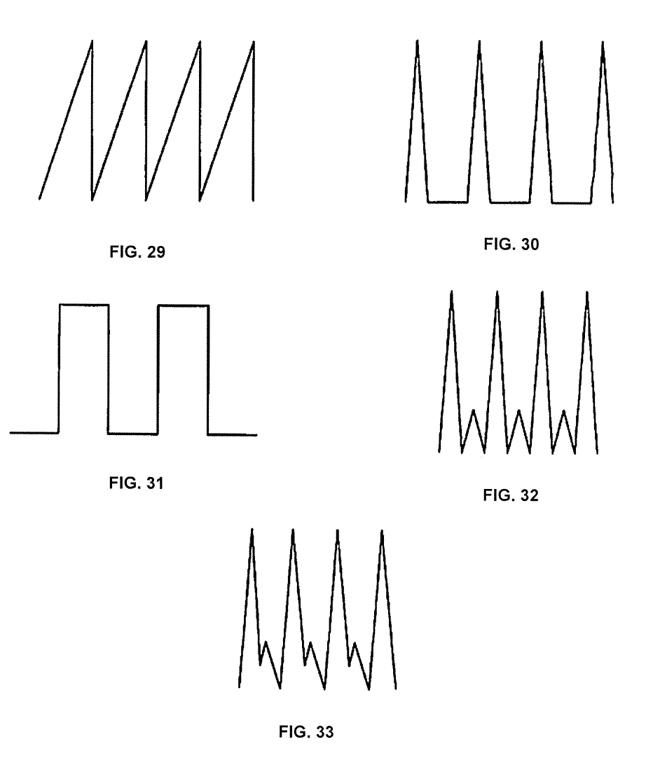

FIGS. 29-33 illustrate a plurality of exemplary pleat formations, which can be advantageously employed in one or both the outer filter element 12 and the inner filter element 14 according to some embodiments of the invention. It should be understood that the exemplary pleat formations shown in FIGS. 29-33 can be supported along an outer circumference such that the pleats and intermediate sections extend radially inward from an cage.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

Various features and advantages of the invention are set forth in the following claims.

1. A fluid filter assembly comprising:
a pleated filter element including a first end, a second end, and a hollow core defining a central axis, the pleated filter element including a plurality of extended pleats separated by one or more intermediate pleats, the extended pleats and the intermediate pleats projecting radially inward to a different length, the radially inward projecting length of the extended pleats being greater than the radially inward projecting length of the intermediate pleats;
an open endcap assembly configured for supporting the first end of the pleated filter element, the open endcap assembly including a fluid inlet in fluid communication with the hollow core; and
a joint endcap configured for supporting the second end of the pleated filter element, the joint endcap being closed to define the hollow core,
wherein fluid flows from within the hollow core through the pleated filter element.

2. A fluid filter assembly as recited in claim 1, wherein the pleated filter element is substantially cylindrical.

3. A fluid filter assembly as recited in claim 1, wherein the radial length of the pleated filter element from the central axis gradually increases from the first end to the second end of the pleated filter element.

4. A fluid filter assembly as recited in claim 1, wherein the radial length of the pleated filter element from the central axis gradually decreases from the first end to the second end of the pleated filter element.

5. A fluid filter assembly as recited in claim 1, further comprising a cage for support of the pleated filter element, the cage generally corresponding to the shape of the pleated filter element and further includes apertures therein for facilitating fluid flow.

6. A fluid filter assembly as recited in claim 1, further comprising an inner filter element including a first end, a second end, and a hollow core, the inner filter element being positioned with the hollow core of the pleated filter element and defining an internal fluid passage between the pleated filter element and the inner filter element,
wherein the pleated filter element now becomes the outer filter element,
wherein fluid flows from within the internal fluid passage through the outer filter element and fluid flows from within the internal fluid passage through the inner filter element into the hollow core of the inner filter element,
wherein the open endcap assembly is further configured for supporting the first end of the inner filter element including a fluid inlet in fluid communication with the internal fluid passage, and
wherein the joint endcap is further configured for supporting the second end of the inner filter element, the joint endcap including a central fluid outlet in fluid communication with the hollow core of the inner filter element.

7. A fluid filter assembly as recited in claim 6, wherein the outer filter element and the inner filter element are supported to be substantially concentric about the central axis.

8. A fluid filter assembly as recited in claim 6, wherein the outer filter element and the inner filter element are substantially cylindrical.

9. A fluid filter assembly as recited in claim 6, wherein the radial length of the outer filter element from the central axis gradually decreases from the first end to the second end of the outer filter element.

10. A fluid filter assembly as recited in claim 6, wherein the radial length of the outer filter element from the central axis gradually increases from the first end to the second end of the outer filter element.

11. A fluid filter assembly as recited in claim 6, wherein the radial length of the inner filter element from the central axis gradually decreases from the first end to the second end of the inner filter element.

12. A fluid filter assembly as recited in claim 6, wherein the radial length of the inner filter element from the central axis gradually increases from the first end to the second end of the inner filter element.

13. A fluid filter assembly as recited in claim 6, further comprising a cage for support of the outer filter element, the cage generally corresponding to the shape of the outer filter element and further including apertures therein :for facilitating fluid flow.

14. A fluid filter assembly as recited in claim 6, wherein the inner filter element comprises a pleated filter media, wherein the pleated filter media includes pleats which generally extend radially inward toward the hollow core.

15. A fluid filter assembly as recited in claim 14, wherein the inner filter element includes a center cage for support of the inner filter element, the center cage generally corresponding to the shape of the hollow core of the inner filter element and further including apertures therein for facilitating fluid flow.

16. A fluid filter assembly comprising:
a pleated filter element including a first end, a second end, and a hollow core defining a central axis, the pleated filter media including a plurality of extended pleats separated by one or more intermediate pleats, the extended pleats and the intermediate pleats projecting radially inward to a different length, the radially inward projecting length of the extended pleats being greater than the radially inward projecting length of the intermediate pleats;
an open endcap assembly configured for supporting the first end of the pleated filter element, the open endcap assembly including a fluid inlet in fluid communication with the hollow core; and
a joint endcap configured for supporting the second end of the pleated filter element, the joint endcap being closed to define the hollow core,
wherein fluid flows from within the hollow core through the pleated filter element,
wherein the radial length of the pleated filter element from the central axis gradually decreases from the first end to the second end of the pleated filter element.

17. A fluid filter assembly as recited in claim 16, further comprising a cage for support of the pleated filter element, the cage generally corresponding to the shape of the pleated filter element and further including apertures therein for facilitating fluid flow.

18. A fluid filter assembly as recited in claim 16, further comprising an inner filter element including a first end, a second end, and a hollow core, the inner filter element being positioned within the hollow core of the pleated filter element and defining an internal fluid passage between the pleated filter element and the inner filter element,
wherein the pleated filter element now becomes the outer filter element,
wherein fluid flows from within the internal fluid passage through the outer filter element and fluid flows from within the internal fluid passage through the inner filter element into the hollow core of the inner filter element,
wherein the open endcap assembly is further configured for supporting the first end of the inner filter element including a fluid inlet in fluid communication with the internal fluid passage,
wherein the joint endcap is further configured for supporting the second end of the inner filter element; the joint endcap further including a central fluid outlet in fluid communication with the hollow core of the inner filter element.

19. A fluid filter assembly as recited in claim 18, wherein the outer and inner filter elements are supported to be substantially concentric about the central axis.

20. A fluid filter assembly as recited in claim 18, wherein the inner filter element is substantially cylindrical.

21. A fluid filter assembly as recited in claim 18, wherein the radial length of the inner filter element from the central axis gradually decreases from the first end to the second end of the inner filter element.

22. A fluid filter assembly as recited in claim 18, wherein the radial length of the inner filter element from the central axis gradually increases from the first end to the second end of the inner filter element.

23. A fluid filter assembly as recited in claim 18, further comprising a cage for support of the outer filter element, the cage generally corresponding to the shape of the outer filter element and further including apertures therein for facilitating fluid flow.

24. A fluid filter assembly as recited in claim 18, wherein the inner filter element comprises a pleated filter media, wherein the pleated filter media includes pleats which generally extend radially inward toward the hollow core.

25. A fluid filter assembly as recited in claim 24, wherein the inner filter element includes a center cage for support of the inner filter element, the center cage generally corresponding to the shape of the hollow core of the inner filter element and further including apertures therein for facilitating fluid flow.

26. A fluid filter assembly comprising:
an outer filter element including a first end, a second end, and a hollow core defining a central axis;
an inner filter element including a first end, a second end, and a hollow core, the inner filter element being positioned within the hollow core of the outer filter element and defining an internal fluid passage between the outer filter element and inner filter element;
an open endcap assembly configured for supporting the respective first end of the outer filter element and the inner filter element, the open endcap assembly including a fluid inlet in fluid communication with the internal fluid passage; and
a joint endcap configured for supporting the respective second end of the outer filter element and the inner filter element, the joint endcap including a central fluid outlet in fluid communication with the hollow core of the inner filter element,
wherein fluid flows from within the internal fluid passage through the outer filter element and fluid flows from within the internal fluid passage through the inner filter element into the hollow core of the inner filter element.

27. A fluid filter assembly as recited in claim 26, wherein the outer filter element and the inner filter element are supported to be substantially concentric about the central axis.

28. A fluid filter assembly as recited in claim 26, wherein the outer filter element and the inner filter element are substantially cylindrical.

29. A fluid filter assembly as recited in claim 26, wherein the radial length of the outer filter element from the central axis gradually decreases from the first end to the second end of the outer filter element.

30. A fluid filter assembly as recited in claim 26, wherein the radial length of the outer filter element from the central axis gradually increases from the first end to the second end of the outer filter element.

31. A fluid filter assembly as recited in claim 26, wherein the radial length of the inner filter element from the central axis gradually decreases from the first end to the second end of the inner filter element.

32. A fluid filter assembly as recited in claim 26, wherein the radial length of the inner filter element from the central axis gradually increases from the first end to the second end of the inner filter element.

33. A fluid filter assembly as recited in claim 26, wherein the outer filter element comprises a pleated filter media including pleats which generally extend radially inward.

34. A fluid filter assembly as recited in claim 33, wherein the outer filter element includes a cage for support of the outer filter element, the cage generally corresponding to the shape of the outer filter element and further including apertures therein for facilitating fluid flow.

35. A fluid filter assembly as recited in claim 33, wherein the pleated filter media includes a plurality of extended pleats separated by one or more intermediate pleats, wherein the extended pleats and intermediate pleats project radially inward to a different length, and wherein the radially inward projecting length of the extended pleats is greater than the radially inward projecting length of the intermediate pleats.

36. A fluid filter assembly as recited in claim 26, wherein the inner filter element comprises a pleated filter media including pleats which generally extend radially inward toward the hollow core.

37. A fluid filter assembly as recited in claim 36, wherein the inner filter element includes a center cage for support of the inner filter element, the center cage generally corresponding to the shape of the hollow core of the inner filter element and further including apertures therein for facilitating fluid flow.

38. A fluid filter assembly comprising:
an outer filter element including a first end, a second end, and a hollow core defining a central axis, the outer filter element including a pleated filter media having a plurality of extended pleats separated by one or more intermediate pleats, the extended pleats and intermediate pleats projecting radially inward to a different length, the radially inward projecting length of the extended pleats being greater than the radially inward projecting length of the intermediate pleats;
an inner filter element including a first end, a second end, and a hollow core, the inner filter element being positioned within the hollow core of the outer filter element and defining an internal fluid passage between the outer filter element and the inner filter element;
an open endcap assembly configured for supporting the respective first end of the outer filter element and the inner filter element, the open endcap assembly including a fluid inlet in fluid communication with the internal fluid passage; and
a joint endcap configured for supporting the respective second end of the outer filter element and the inner filter element, the joint endcap including a central fluid outlet in fluid communication with the hollow core of the inner filter element,
wherein fluid flows from within the internal fluid passage through the outer filter element and fluid flows from within the internal fluid passage through the inner filter element into the hollow core of the inner filter element.

39. A fluid filter assembly as recited in claim 38, wherein the outer filter element and the inner filter element are supported to be substantially concentric about the central axis.

40. A fluid filter assembly as recited in claim 38, wherein the outer filter element and the inner filter element are substantially cylindrical.

41. A fluid filter assembly as recited in claim 38, wherein the radial length of the outer filter element from the central axis gradually decreases from the first end to the second end of the outer filter element.

42. A fluid filter assembly as recited in claim 38, wherein the radial length of the outer filter element from the central axis gradually increases from the first end to the second end of the outer filter element.

43. A fluid filter assembly as recited in claim 38, wherein the radial length of the inner filter element from the central axis gradually decreases from the first end to the second end of the inner filter element.

44. A fluid filter assembly as recited in claim 38, wherein the radial length of the inner filter element from the central axis gradually increases from the first end to the second end of the inner filter element.

45. A fluid filter assembly as recited in claim 38, further comprising a cage for support of the outer filter element, the cage generally corresponding to the shape of the outer filter element and further including apertures therein for facilitating fluid flow.

46. A fluid filter assembly as recited in claim 38, wherein the inner filter element comprises a pleated filter media including pleats which generally extend radially inward toward the hollow core.

47. A fluid filter assembly as recited in claim 46, wherein the inner filter element includes a center cage for support of the inner filter element, the center cage generally corresponding to the shape of the hollow core of the inner filter element and further including apertures therein for facilitating fluid flow.

48. A fluid filter assembly comprising:
an outer filter element including a first end, a second end, and a hollow core defining a central axis, the outer filter element including a pleated filter media having a plurality of extended pleats separated by one or more intermediate pleats, the extended pleats and intermediate pleats projecting radially inward to a different length, the radially inward projecting length of the extended pleats being greater than the radially inward projecting length of the intermediate pleats, the radial length of the outer filter element from the central axis gradually decreasing from the first end to the second end;
an inner filter element including a first end, a second end, and a hollow core, the inner filter element being positioned within the hollow core of the outer filter element and defining an internal fluid passage between the outer filter element and inner filter element;
an open endcap assembly configured for supporting the respective first end of the outer filter element and the inner filter element, the open endcap assembly including a fluid inlet in fluid communication with the internal fluid passage; and
a joint endcap configured for supporting the respective second end of the outer filter element and the inner filter element, the joint endcap including a central fluid outlet in fluid communication with the hollow core of the inner filter element,
wherein fluid flows from within the internal fluid passage through the outer filter element and fluid flows from within the internal fluid passage through the inner filter element into the hollow core of the inner filter element.

49. A fluid filter assembly as recited in claim 48, wherein the outer filter element and the inner filter element are supported to be substantially concentric about the central axis.

50. A fluid filter assembly as recited in claim 48, wherein the inner filter element is substantially cylindrical.

51. A fluid filter assembly as recited in claim 48, wherein the radial length of the inner filter element from the central axis gradually decreases from the first end to the second end of the inner filter element.

52. A fluid filter assembly as recited in claim 48, wherein the radial length of the inner filter element from the central axis gradually increases from the first end to the second end of the inner filter element.

53. A fluid filter assembly as recited in claim 48, and further comprising a cage for support of the outer filter element, the cage generally corresponding to the shape of the outer filter element and further including apertures therein for facilitating fluid flow.

54. A fluid filter assembly as recited in claim 48, wherein the inner filter element comprises a pleated filter media including pleats which generally extend radially inward toward the hollow core.

55. A fluid filter assembly as recited in claim 54, wherein the inner filter element includes a center cage for support of the inner filter element, the center cage generally corresponding to the shape of the hollow core of the inner filter element and further including apertures therein for facilitating fluid flow.
